(19) United States
(12) Patent Application Publication
(10) Pub. No.: US 2012/0211714 A1
(43) Pub. Date: Aug. 23, 2012

(54) FENCE SYSTEM WITH INSECT BARRIER

(76) Inventor: Rosario Esposito, Shelby Township, MI (US)

(21) Appl. No.: 13/460,735

(22) Filed: Apr. 30, 2012

Related U.S. Application Data
(63) Continuation of application No. 12/950,800, filed on Nov. 19, 2010, now Pat. No. 8,167,276.
Application No. 12/950,800 is a continuation of application No. 12/128,317, filed on Aug. 12, 2008, now Pat. No. 7,857,292.
Application No. 12/128,317 is a continuation of application No. 10/971,989, filed on Oct. 22, 2004, now abandoned.

(51) Int. Cl. E04H 17/20; B23P 11/00

(52) U.S. Cl. 256/65.02; 29/428

(57) ABSTRACT

A fence system and method of manufacturing a fence includes a fence post and a rail inserted into and supported by the fence post. The rail is inserted into an aperture located in a sidewall of the post, the aperture having a shape that is substantially the same as the cross-sectional shape of the rail. Gaps between the opening in the post and the rail, once the rail is inserted into the post, are minimized so as to prevent insects from gaining access to the inside of the post.

### CROSS-REFERENCE TO RELATED APPLICATIONS

This application is a Continuation of application Ser. No. 12/950,800 filed Nov. 19, 2010, now U.S. Pat. No. 8,167,276; which is a Continuation of application Ser. No. 12/128,317, filed Aug. 12, 2008, now U.S. Pat. No. 7,857,292; which is a Continuation of application Ser. No. 10/971,989 filed on Oct. 22, 2004, now abandoned.

### BACKGROUND OF THE INVENTION

1. Field of the Invention

The present invention relates generally to a rail type fence system including a fence post and rails. More specifically, the invention is directed to a rail type fence system having a configuration that limits access to the interior of the fence post and rail components to prevent formation of insect nests.

2. Description of Related Art

Fences are almost as old as humanity. Over the years, fences of all types and kinds, from rock walls to barbed wire, were built with one of two purposes in mind, keep things in or keep them out. For instance, fences are used to keep livestock in a certain area or are placed around a particular area to prevent access thereto. Today, fences also provide a decorative touch or provide privacy.

One of the more common fence systems presently used is a fence post and rail combination, wherein the fence posts are placed at spaced intervals. Horizontal rails are placed between the fence posts. One example of a fence post and rail combination is the standard split rail fence seen throughout much of rural America typically used to contain livestock. In many instances, attached to the rails are fence elements or pickets forming what we refer to today as a picket fence.

FIGS. 4-5 illustrate a prior art design for closing a gap or opening. Specifically, a plurality of preformed plugs are inserted into the channel between the sidewalls and up to the web member thereof. The plugs operate to form a seal that reduces access to the interior of the fence post. The plugs are formed in accordance with the specific size and configuration of the rail. Thus, a stock of variably sized plugs is necessary depending upon the design and parameters of the fence system. In addition, the cost of manufacturing and storing the plugs can make such a system too expensive for all but very small uses. Further, it should be taken into account that inserting a plug in each rail at every fence post and rail junction is a time-consuming and laborious procedure, which, for large amounts of fencing, can be cost prohibitive.

From the above, it can be appreciated that modular fence systems are not fully optimized to provide a simpler, less costly fence system that reduces the opportunity for insect infestation in the fence components, particularly the fence posts. Therefore, what is needed is a fence post and rail system that fits together without any appreciable gap or opening between the fence post and rail and thereby reduces the opportunity for insect infestation within the fence post.

### BRIEF SUMMARY OF THE INVENTION

According to the preferred embodiment of the present invention, there is provided a fence system including a fence post and a rail for insertion into an aperture in the fence post. The rail has a channel or U-shaped cross section that results in one side being open. The aperture in the fence post is configured similar to the cross section of the rail and includes an upstanding portion or tab. The upstanding portion or tab is sized such that it fits within the channel or interior of the U-shaped cross section to block access to the interior of the fence post. Thus, the present invention is capable of successfully incorporating the benefits of a fence system with an integrated insect barrier without the need for additional plugs or stop members.

It is an object of the present invention to provide a fence system for use with rails having generally a channel or U-shaped cross section. The fence post includes an aperture having an upstanding portion or tab that fits within the channel. Wherein the rails fit snugly into the aperture in the fence post to block access to the interior of the fence post and prevent insect infestation, including the creation of nests within the interior of the fence post.

It is a further object of the present invention to provide a fence system including fence posts and rails, wherein the fence post includes an aperture for receiving the rail. The aperture in the fence post for receiving the rail corresponds to the shape or configuration of the cross section of the rail such that the rail fits securely within the fence post without any appreciable gaps or openings that would allow for possible insect infestation within the hollow area of the fence post.

These objects and other features, aspects and advantages of this invention will be more apparent after a reading of the following detailed description, appended claims and accompanying drawings.

### BRIEF DESCRIPTION OF THE DRAWINGS

FIG. 1 is an exploded perspective view of a fence system according to the preferred embodiment of the present invention;

FIG. 2 is a partial side view of the fence post of FIG. 1 illustrating an aperture configured in accordance with the present invention;

FIG. 3 is a partial, cross-sectional side view of the fence post of FIG. 1 illustrating a rail having a substantially U-shaped cross section disposed within the aperture in accordance with the present invention;

FIG. 4 is a partial side view of a prior art fence system utilizing a plug placed within the channel of the rail; and

FIG. 5 is a cross-sectional view of the prior art fence system taken along lines 5-5 of FIG. 4.

FIG. 6 is a partial cross-sectional view similar to FIG. 3, but illustrating an alternate rail, having a substantially L-shaped cross-section and an alternate fence post having an aperture having the same configuration or profile as the cross-section of the rail.

### DETAILED DESCRIPTION OF THE PREFERRED EMBODIMENT

As discussed above, FIGS. 4-5 illustrate a prior art fence systems 102 that utilizes a rail 104 having a substantially U-shaped cross section 106. The rail 104 is inserted into an aperture 108 located in a hollow fence post 110. The aperture 108 is typically a rectangular or square opening of a size suitable to accept the three sides of the U-shaped rail 104, specifically, the web 112 and two legs or sides 114 of the U-shaped cross section. Therefore, this type of fence system 102 inherently has a problem in that it provides a gap or opening that allows access to the interior of the fence post 110.

In an attempt to solve this problem, plugs 116 sized to fit between the leg or sides 114 of the U-shaped rail 104 are inserted adjacent the fence post 110. Use of the plug 116, while closing the gap or opening, creates additional costs associated with both manufacturing the plugs 116 and the labor to insert the plugs 116 at each and every joint between the fence post 110 and rail 104. Since this plug is inserted using only an interference fit, it is unknown at this time, whether exposure to the elements, over time, will work its way loose and expose the gap or opening in the rail.

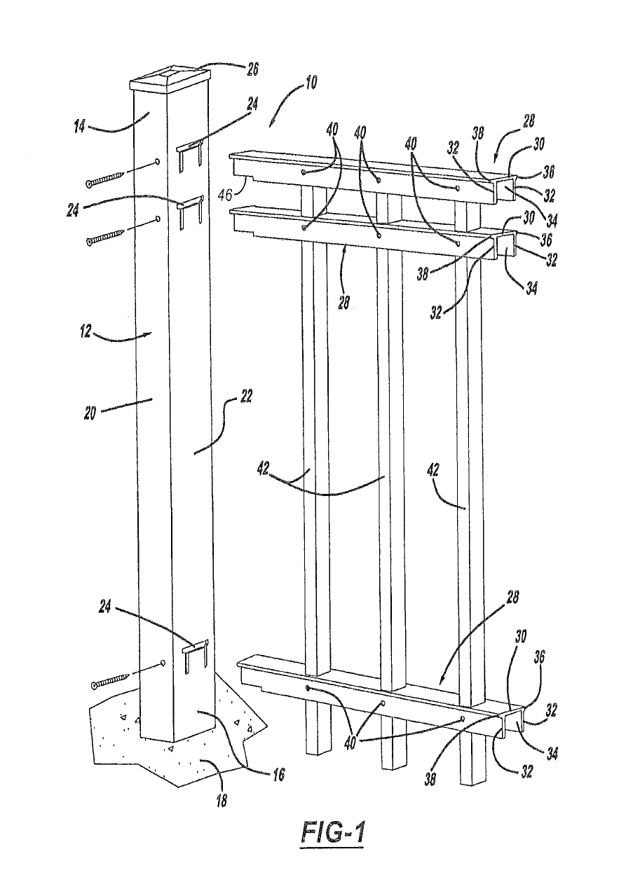

Referring now to FIG. 1, there is shown a perspective view of a modular fence system 10 according to an embodiment of the present invention. The modular fence system 10 in includes a fence post 12. The fence post 12_has a cavity and includes an upper end 14 and a lower end 16 that is embedded in the ground 18 using well known prior art teachings for anchoring the post. The fence post 12 is hollow or tubular and includes a front sidewall 20 and a right sidewall 22. It should be understood that the fence post 12 shown in the present invention has a square configuration or cross section and thus includes a rear and left sidewall that is not shown in the drawings. As the fence post 12 is hollow or tubular, each of the front and right sidewalls 20, 22, along with the rear and left sidewalls (not shown) will have interior and exterior surfaces. It should also be understood that although the preferred embodiment describes a square post, other geometric configurations for the post are contemplated in practicing the invention as described herein.

The fence post 12 shown in FIG. 1 is used as an end post and includes three apertures 24 located in the right sidewall 22. If the fence post 12 were to be used as an in-line post it would include additional openings or apertures 24 formed in the left sidewall. If used as a corner post, additional openings or apertures 24 are formed in either the front 20 or rear sidewall depending upon the particular corner formed by the fence post 12. While shown with three openings or apertures 24, the fence post 12 according to the present invention may include a lesser or greater number of openings or apertures 24 depending upon the amount or number of rails 28 forming the fence assembly or system 10. A cap 26 is placed on the upper end 14 of the fence post 12 to cover the upper or open end 14 thereof.

The modular fence system 10 further includes a rail 28. The rail 28 is an elongated substantially U-shaped channel member having an end or web member 30 and side flange members 32 extending substantially perpendicular from the end or web member 30. The side flange members 32 define a gap or opening 34 therebetween. As shown herein, the edges 36, 38 of the end or web member 30 are rounded and extend slightly past the side flange members 32. The rail 28 further includes a plurality of apertures 40 located in the respective side flange members 32.

As shown in FIG. 1 a plurality of fence elements or pickets 42 are fastened to the rails 28. The fence elements or pickets 42 extend up to or through the end or web member 30, and are fastened to the rail 28 by fasteners extending through the apertures 40 located in the side flange members 32 of the rails 28. The rails 28 have a notched portion 46 that provides a stop for the rail 28 as it enters the opening 24 of the post 12. Once the rail 28 is inserted into the opening 24, a seal is created. The number of fence elements or pickets 42 along with the placement or spacing thereof is a design choice. The invention set forth herein is suitable for use with out fence elements or pickets 42 extending between the respective rails 28.

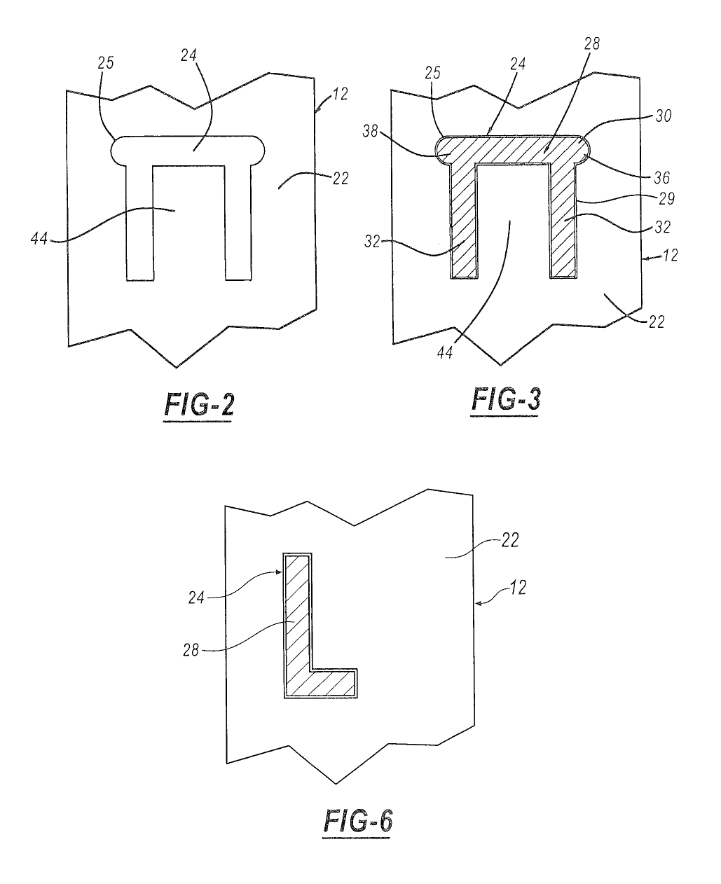

Turning now to FIG. 2 there is shown the aperture or opening 24 in the post in detail. Specifically, an upstanding portion or tab 44 extends upwardly into the aperture or opening 24. The upstanding portion or tab 44 has a shape or configuration complementary to the shape or configuration of the gap or opening 34 located between the respective side flange members 32 of the rail 28. The upstanding portion or tab 44 has a length substantially equal to the length of the respective side flange members 32 such that it ends in close proximity to the end or web member 30 of the rail 28. It will be apparent that the configuration or shape of the opening or aperture 24 is substantially the same as a cross-sectional shape of the inner configuration of the U-shaped channel of the rail 28. Accordingly, as shown in FIG. 3 when the rail 28, shown in cross-section, is inserted into the opening or aperture 24, it fits such that there is no significant gap or opening between the outer periphery of the rail and the inner periphery of the aperture 24 in the post to allow access to the interior of the fence post 12. As shown in FIG. 3, the peripheral edge 25 of the opening or aperture 24 substantially corresponds with the outer configuration of the rail 28 to create a seal 29 to prevent access by insects and thereby avoid insect infestation within the hollow interior of the fence post 12. The outer configuration, cross-section, or profile of the rail 28 is slightly smaller than the peripheral edge 25 of the aperture 24. No insects can pass between the outer profile of the rail 28 and the aperture 24. This creates a sealed fence system. Insects cannot enter the cavity of the hollow post 12, thus creating an insect-free fence system.

It should be understood that the present invention provides an aperture or opening 24 that substantially corresponds to both the outer configuration or shape of the rail 28 and the inner configuration or shape of the rail 28. That is, the shape of the aperture or opening 24 substantially corresponds to the cross-section of the rail 28. Accordingly, the rail 28 is shown herein as having a substantially U-shaped cross-section with a gap or opening 34 formed by the side flange members 32 of the rail 28. Correspondingly, the aperture or opening 24 of the post 12 includes having an upstanding portion or tab 44 extending upward into the aperture 24. The upstanding portion or tab 44 is sized to fit within the gap or opening 34.

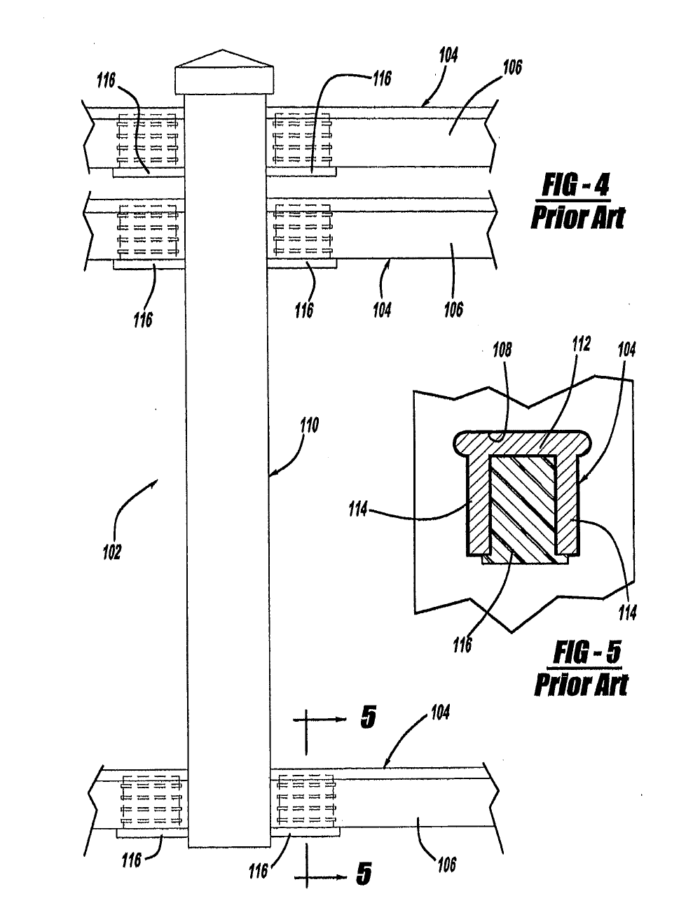

Other configurations, such as a concave polygon shape can be used as long as the aperture or opening 24 has a corresponding concave polygon shape such that any gap existing between the aperture or opening 24 and the rail 28, when the rail 28 is inserted into the post 12 is minimal. Making the gap minimal reduces the opportunity for insects to access the interior of and build nests within the interior of the post 12. For example, as shown in FIG. 6, if the rail 28 had an L-shape or angle configuration or cross-section, then the opening or aperture 24 should have the same configuration.

According to the present invention, the opening or apertures 24 in the fence post 12 are stamped or cut into the sidewall, shown in FIG. 1 as the right sidewall 22, of the fence post 12 in a configuration corresponding to the particular cross-section of the rail 28. Doing so provides a snug fit between the rail 28 and the fence post 12 while at the same time limiting access to the interior or hollow portion of the fence post 12. Furthermore, the present invention does not require any additional parts or components in the form of plugs or other parts to reduce the possibility of insect infestation within various components of the fence system 10. In addition, the foregoing invention may be used with other components of a fence system 10. For example, depending upon the shape and configuration of the rails, the fence elements or pickets 42 may be installed in the rails in a similar manner.

While the present invention has been described in terms of a preferred embodiment, it is apparent that other forms could be adopted by one skilled in the art. In other words, the teachings of the present invention encompass any reasonable substitutions or equivalents of claim limitations. Accordingly the scope of the present invention is to be limited only by the following claims.

1.-12. (canceled)

13. A fence system comprising:
a post having a cavity and at least one sidewall having a curve shaped opening, said shaped opening includes a first portion, a second portion, and another portion, the first and second portions extending downwardly to define a tab extending upwardly into the opening; and
a fence rail connected to said post, said rail having an exterior profile configured to be received within said opening of said post, said rail having a cross-section that is similar to the profile of the opening resulting in a minimal gap between said opening and said rail such that insects are precluded from entering the opening in said post.

14. The fence as claimed in claim 13, wherein the first and second portions are vertical.

15. The fence as claimed in claim 13, wherein the curve shaped opening is U-shaped.

16. The fence as claimed in claim 13, wherein the curve shaped opening is concave.

17. The fence as claimed in claim 13, wherein the sidewall of the post supports the rail.

18. The fence as claimed in claim 13, wherein the tab has a uniform width.

19. The fence as claimed in claim 13, further comprising:
at least two rails;
at least two posts, each having at least two openings, each opening accepting one of said rails.

20. The fence as claimed in claim 13, wherein the first and second portions are aligned vertically, and said another portion is aligned horizontally.

21. The fence as claimed in claim 13, further comprising a cap on an end of the post wherein once the post, cap and fence rail are assembled, a sealed fence is created precluding insects from entering the cavity.

22. The fence as claimed in claim 13, wherein the shape is selected from a generally polygonal shape, a generally Pi-shape, and a generally U-shaped configuration.

23. The fence as claimed in claim 13, comprising:
at least two rails;
at least two posts, each having at least two of said openings, each of said openings accepting one of said rails; and
a plurality of pickets extending between and connecting said first and second rail members.

24. The fence as claimed in claim 23, wherein the posts and the rail members are sealed so as to preclude insects from entering the cavity of the fence.

25. The fence as claimed in claim 13, comprising:
at least two of said rails;
at least two of said posts, each having at least two of said openings, each said opening accepting one of said rails; and
a plurality of pickets extending between and connecting said first and second rail members.

26. The fence as claimed in claim 13, wherein the rail has proximate each longitudinal end a notched portion that butts up against the outer surface of said sidewall of said post such as to prevent the open fence rail from passing through the opening beyond a predetermined amount during assembly of the open fence rail to the post.

27. The fence as claimed in claim 13, wherein a profile of the rail is selected from a generally U-shaped configuration, or a generally Pi-shaped configuration.

28. A method of manufacturing a fence comprising:
providing a hollow fence post, said post having a wall with an opening with a curved configuration, said curved configuration including an opening with a first downwardly extending portion, a second downwardly portion, and an intermediate portion having opposing ends, each of said downwardly extending portions being offset from said ends and extending parallel to one another to define a tab of uniform width extending upwardly into the opening;
providing at least one fence rail, said rail having a cross-sectional shape that is complementary to the curved configuration of the opening in the post, and
inserting an end of the rail into the opening in the post, the end of the rail being configured to fit snug in the opening such that the space between the end of the rail and the opening is limited and prevents insects from entering the post.

29. The method as claimed in claim 28, wherein the curved configuration is selected from a generally concave polygonal configuration, a generally U-shaped configuration, a generally L-shaped configuration, and a generally Pi-shaped configuration.

30. The method as claimed in claim 28, wherein said step of inserting comprises inserting said rail through said opening until a portion of the rail not having said second generally concave configuration abuts said wall.

31. The method as claimed in claim 28, further comprising applying a seal between the rail and the wall of the post to block insects from entering the post.

32. A method of assembling a fence system comprising:
providing a fence post, said post having a wall with an opening with a generally U-shaped configuration, said configuration including an opening with a first vertical extending portion, a second vertical extending portion, and an intermediate portion having opposing ends, each of said vertical extending portions being offset from said ends and extending offset from one another to define a tab extending upwardly into the opening;
providing at least one fence rail, said rail having a cross-sectional shape that is complementary to the configuration of the opening in the post, and
inserting an end of the rail into the opening in the post, the end of the rail being fitted such that the space between the end of the rail and the opening is limited and prevents insects from entering the post.
